(19) United States
(12) Patent Application Publication
(10) Pub. No.: US 2010/0329675 A1
(43) Pub. Date: Dec. 30, 2010

(54) INTERFACE CIRCUIT

(76) Inventor: KEIICHI OKUYAMA, Tokyo (JP)

Correspondence Address: Mr. Jackson Chen, 6535 N. STATE HWY 161, IRVING, TX, 75039, US

(21) Appl. No.: 12/825,634

(22) Filed: Jun. 29, 2010

(30) Foreign Application Priority Data
Jun. 30, 2009 (JP) 2009-155622

(51) Int. Cl. H04J 14/00

(52) U.S. Cl. 398/45

(57) ABSTRACT

The interface circuit of the present invention comprises: a first framer configured to input or output a first standard frame compliant with a first standard to or from a transmission path; and a second framer connected to the first framer and configured to input or output a second standard frame compliant with a second standard from or to an in-device interface. The second framer comprises a second framer transmission section configured to input a transmission data from the in-device interface and generate a second standard frame with the transmission data in a payload. The first framer comprises a first framer transmission section connected to the second framer transmission section and configured to input the generated second standard frame from the second framer transmission section, generate a first standard frame with the generated second standard frame and output the generated first standard frame to the transmission path; and a first framer reception section configured to input a first standard frame from the transmission path, terminate the inputted first standard frame and generate a second standard frame with a reception data stored in a payload of the inputted first standard frame. The second framer further comprises a second framer reception section connected to the first framer reception section and configured to input the generated second standard frame from the first framer reception section, terminate the inputted second standard frame and output the reception data stored in the inputted second standard frame to the in-device interface.

### INCORPORATION BY REFERENCE

This application claims the benefit of priority based on Japanese Patent Publication No. 2009-155622, filed on Jun. 30, 2009, the disclosure of which is incorporated herein by reference.

### BACKGROUND OF THE INVENTION

1. Field of the Invention

The present invention relates to an interface circuit provided with a framer compliant with a SONET (Synchronous Optical NETwork)/SDH (Synchronous Digital Hierarchy) system.

2. Description of Related Art

An interface compliant with a SONET/SDH system is sped up. An interface circuit compliant with STM-256 provided in ITU-T (International Telecommunication Union Telecommunication Standardization Sector) G.707, or OC-768 provided in Telccrdia GR253 is developed.

FIG. 1 is a functional block diagram illustrating a configuration of a framer provided in the conventional interface circuit compliant with STM-256/OC-768. The STM-256/PC-768 framer (hereinafter referred to as a 40 G framer) in FIG. 1 is provided with a 40 G framer reception section 51 and a 40 G framer transmission section 52.

The 40 G framer, reception section 51 is provided with an SOH (Section OverHead) processing section 511, a PTR (PoinTeR) processing section 512, and a POH (Path OverHead) processing section 513. The SOH processing section 511 extracts an SOH from an STM-256/OC-768 signal inputted from a transmission path to perform termination processing. The PTR processing section 512 performs contiguous concatenation processing of VC4-256c, VC4-64c, and VC4-16c for an SOH-terminated frame inputted from the SOH processing section; makes a change from a clock of the transmission path to an internal clock of a multiplex transmission device; and performs pointer detection processing to detect a head position of a payload. The POH processing section 513 extracts POHs respectively corresponding to pointers of VC4-256c, VC4-64c, VC4-16c, VC3-768, and VC4-256 to perform termination processing.

On the other hand, the 40 G framer transmission section 52 is provided with an SOH inserting section 521. The SOH inserting section 521 performs SOH insertion compliant with STM-256/OC-768 into a main signal inputted from an in-device interface to output it to the transmission path as the STM-256/OC-768 signal.

However, in the case of the interface circuit corresponding to STM-256/OC-786, upon design of the 40 G framer, an LSI (large Scale Integration) corresponding to the entire hierarchy of the SDH/SONET should be developed. In particular, regarding the pointer processing, in addition to the contiguous concatenation processing of VC4-256c, VC4-64c, VC4-16c, and the like, the pointer processing is performed at a fine granularity such as VC3×768 or VC4×256, and therefore a large number of pointer processing circuits should be provided, which causes a problem of increasing a circuit scale. Also, regarding RSOH (Regenerator SOH) in the SOH inserted into a transmitted frame, the number of bytes to be processed is increased according to a multiplicity, and therefore there is a problem that a corresponding circuit is also increased in size.

Patent literature 1 discloses a signal speed converter that is provided independently of a wavelength multiplex transmission terminal station; can be connected to the wavelength multiplex transmission terminal station through a low speed optical line such as a short distance SONET line, or Ethernet LAN-PHY; and is not required to be mounted with an inter-station optical interface having high wavelength dependency.

The signal speed converter in Patent literature 1 includes: a first optical interface that transmits/receives an information frame having a first format as a serial optical signal or a logical set of parallel optical signals, and is connected to a first optical line or an optical line group; a plurality of second optical interfaces that respectively transmit/receive information frames having a second format as optical signals, and are connected to a second optical line group; and a speed conversion section that is arranged between the first optical interface and the second optical interfaces. The first optical interface has a first framer that terminates the information frame having the first format transmitted/received or received through the first optical line group, and converts an original information signal within the information frame to a serial signal string or a logical set of parallel signal strings. The speed conversion section cyclically distributes the serial signal string or logical set of parallel signal strings inputted/outputted from/to the first framer to a plurality of internal lines corresponding to the second optical interfaces to convert the signal string(s) to a plurality of signal strings each including the interleaved original information signal. The second optical interfaces respectively have second framers that convert the plurality of signal strings interleaved in the plurality of corresponding internal lines into the information frame having the second format. Also, the speed converter is provided with: a plurality of management information means that are intended to duplicate management information to be communicated with another signal speed converter facing to the signal speed converter through an external wavelength multiplex optical transmission path to individually insert the duplicates into the plurality of signal strings; and management information extraction means adapted to extract the management information.

Also, Patent literature 2 is intended to provide an integrated circuit that processes a signal of MGbps bit rate and a signal of NGbps corresponding to a quadrupled bit rate of the MGbps signal, and further discloses an integrated circuit that is intended to perform conversion between a 10 Gbps or 40 Gbps client signal and OTU2 or OTU3.

Patent literature 3 discloses an apparatus for converting an interface between pieces of high speed data having various capacities, which enables pieces of data having various large capacities to be accommodated and selectively interfaced using one circuit.

Patent literature 1: Japanese Patent Publication No. 2009-055212A

Patent literature 2: Japanese Patent Publication No. 2008-092410A

Patent literature 3: Japanese Patent Publication No. 2008-148302A

### SUMMARY OF THE INVENTION

An object of the present invention is to provide an interface circuit that prevents an increase in newly designed circuit size and can be realized through simple design.

The interface circuit of the present invention comprises: a first framer configured to input or output a first standard frame compliant with a first standard to or from a transmission path; and a second framer connected to the first framer and configured to input or output a second standard frame compliant with a second standard from or to an in-device interface. The second framer comprises a second framer transmission section configured to input a transmission data from the in-device interface and generate a second standard frame with the transmission data in a payload. The first framer comprises a first framer transmission section connected to the second framer transmission section and configured to input the generated second standard frame from the second framer transmission section, generate a first standard frame with the generated second standard frame and output the generated first standard frame to the transmission path; and a first framer reception section configured to input a first standard frame from the transmission path, terminate the inputted first standard frame and generate a second standard frame with a reception data stored in a payload of the inputted first standard frame. The second framer further comprises a second framer reception section connected to the first framer reception section and configured to input the generated second standard frame from the first framer reception section, terminate the inputted second standard frame and output the reception data stored in the inputted second standard frame to the in-device interface.

The method of transmitting and receiving data of the present invention comprises: inputting a transmission data from an in-device interface; generating a second standard frame with the transmission data in a payload; generating a first standard frame with the generated second standard frame; outputting the generated first standard frame to a transmission path; inputting a first standard frame from the transmission path; terminating the inputted first standard frame; generating a second standard frame with a reception data stored in a payload of the inputted first standard frame; terminating the generated second standard frame; and outputting the reception data stored in the inputted second standard frame to the in-device interface.

According to the present invention, there can be provided an interface circuit that prevents an increase in newly designed circuit size and can be realized through simple design.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a functional block diagram illustrating a configuration of a framer provided in a conventional interface circuit compliant with STM-256/OC-768;

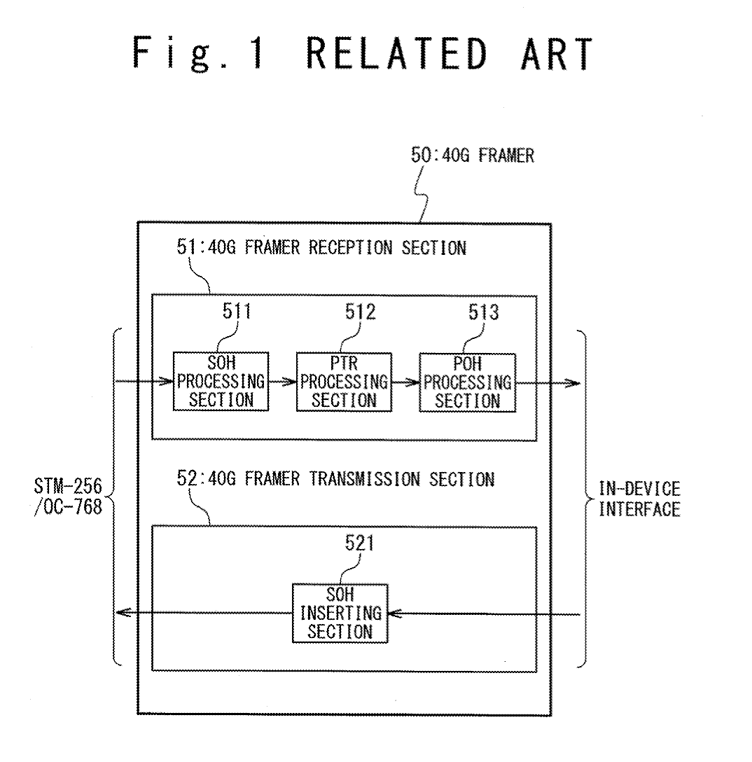

FIG. 2 is a functional block diagram illustrating an outline of a configuration of an interface circuit 1 in the present embodiment;

FIG. 3 is a functional block diagram illustrating the interface circuit 1 in an embodiment of the present invention in more detail;

FIG. 4 is a diagram illustrating a transmission sequence of the interface circuit 1 of an embodiment of the present invention in detail;

FIG. 5A is a diagram illustrating a reception sequence of the interface circuit 1 of an embodiment of the present invention in detail; and

FIG. 5B is a diagram illustrating the reception sequence of the interface circuit 1 of an embodiment of the present invention in detail.

### DESCRIPTION OF PREFERRED EMBODIMENTS

Hereinafter, an interface circuit according to an embodiment of the present invention will be described by referring to the accompanying drawings.

### First Embodiment

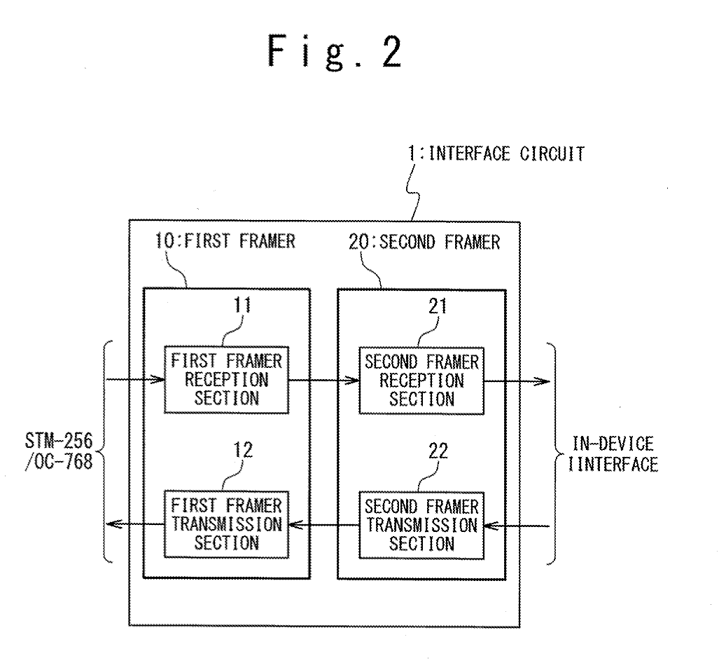

First, referring to FIG. 2, an outline of a configuration of the interface circuit in the present embodiment is described. FIG. 2 is a functional block diagram illustrating the outline of a configuration of the interface circuit 1 in the present embodiment. The interface circuit 1 of the present embodiment is provided with a first framer 10 and a second framer 20. Also, the first framer 10 is further provided with a first framer reception section 11 and a first framer transmission section 12. The second framer 20 is further provided with a second framer reception section 21 and a second framer transmission section 22.

The second framer transmission section 22 is connected to an unillustrated in-device interface and the first framer transmission section 12. The second framer transmission section 22 generates a second frame that stores transmission data inputted from the in-device interface. Note that the second frame is configured in a frame format compliant with STM-64 (9.6 Gbps) provided in ITU-T G.707, or OC-192 (9.6 Gbps) provided in Telcordia GR-253-CORE. When the second framer transmission section 22 generates the second frame, it outputs the second frame to the first framer transmission section 12 as an STM-64/OC-192 signal.

The first framer transmission section 12 is connected to the second framer transmission section 22 and an unillustrated transmission path. The first framer transmission section 12 is inputted with the second frame from the second framer transmission section 22 as the STM-64/OC-192 signal. The first framer transmission section 12 multiplexes the second frame to generate a first frame. Note that the first frame is configured in a frame format compliant with STM-256 (40 Gbps) provided in ITU-T G.707, or OC-768 (40 Gbps) provided in Telccrdia GR-253-CORE. When the first framer transmission section 12 generates the first frame, it outputs the first frame to the transmission path as an STM-256/OC-768 signal.

On the other hand, the first framer reception section 11 is connected to the second framer reception section 21 and the transmission path. The first framer reception section 11 receives the first frame from the transmission path as the STM-256/OC-768 signal. The first frame is, as described above, configured in the STM-256/OC-768 (40 Gbps) frame format. The first framer reception section 11 terminates the first frame, and separates the transmission data multiplexed in the first frame. The first framer reception section 11 generates the second frame that is to store reception data multiplexed in the first frame. The second frame is, as described above, configured in the STM-64/OC-192 frame format. When the first framer reception section 11 generates the second frame, it outputs the second frame to the second framer reception section 21 as the STM-64/OC-192 signal.

The second framer reception section 21 is connected to the first framer reception section 11 and the in-device interface. The second framer reception section 21 is inputted with the second frame from the first framer reception section 11 as the STM-64/OC-192 signal. The second framer reception section 21 terminates the second frame, and outputs the reception data stored in the second frame to the in-device interface.

Note that although illustration is omitted, the interface circuit 1 of the present embodiment is provided with four second framers 20-1 to 20-4. The first framer 10 receives the second frames (STM-64/OC-192 frames) from the four second framers 20-1 to 20-4, and performs byte multiplexing compliant with ITU-T G.707 or Telcordia GR-253-CORE to generate the first frame (STM-256/OC-768 frame). Similarly, when the first framer 10 receives the first frame, it separates the first frame into the four second frames to transmit them to the respective second framers 20-1 to 20-4. The second framers 20-1 to 20-4 respectively have the same configurations, and therefore in the following description, are described as the second framers 20 unless they are particularly specified.

As described, the interface circuit 1 of the present embodiment is provided with the first framer 10 and the second framers 20. Each of the second framers 20 is applicable with the conventional STM-64/OC-192 framer. The first framer 10 specializes in performing processing of the STM-256/OC-768 frame. In order to make an interface common to enable signal transmission/reception to/from the second framers 20, the first framer 10 terminates the first frame to generate the second frames. Also, the first framer 10 receives the second frames transmitted from the second framers 20 to generate the first frame. Based on such a configuration, it is only necessary to use the conventional STM-64/OC-192 framers for the second framers 20, and configure a circuit specializing in processing of the STM-256/OC-768 frame for the first framer 10, so that a circuit size of the interface circuit 1 can be suppressed from increasing, and a newly designed circuit can be realized through simple design.

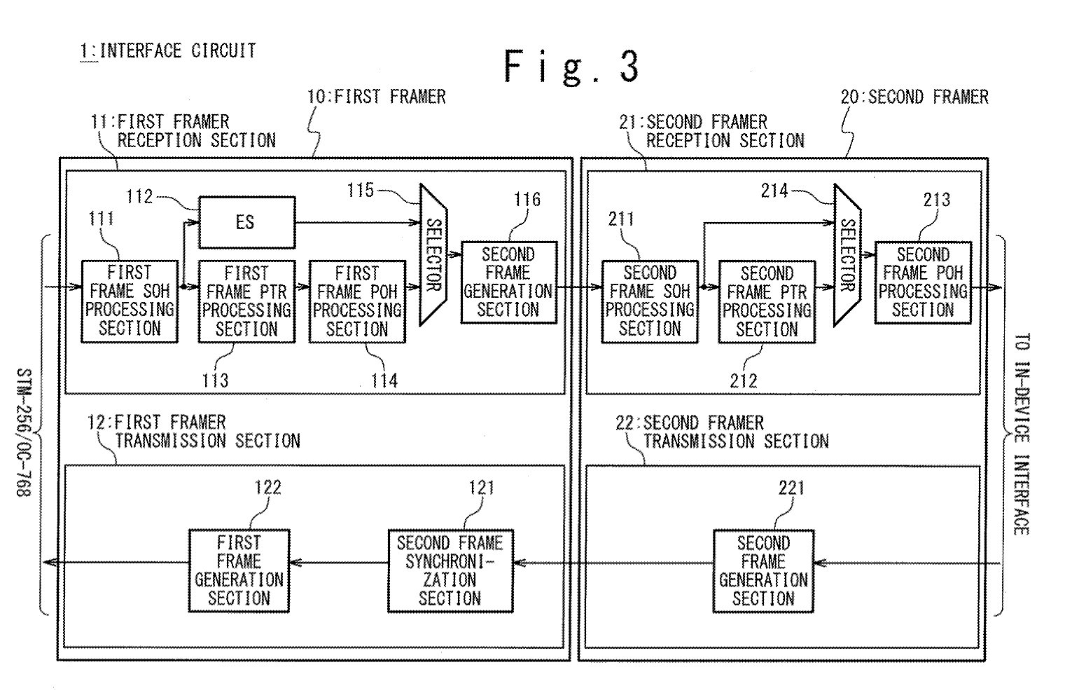

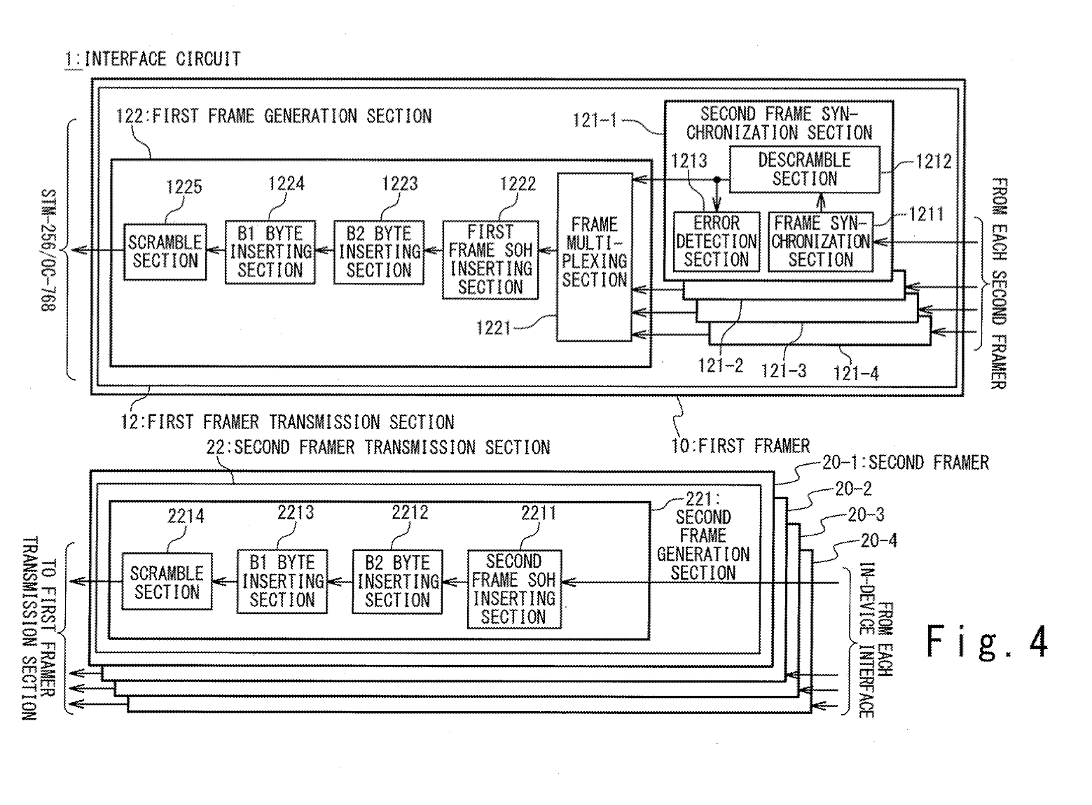

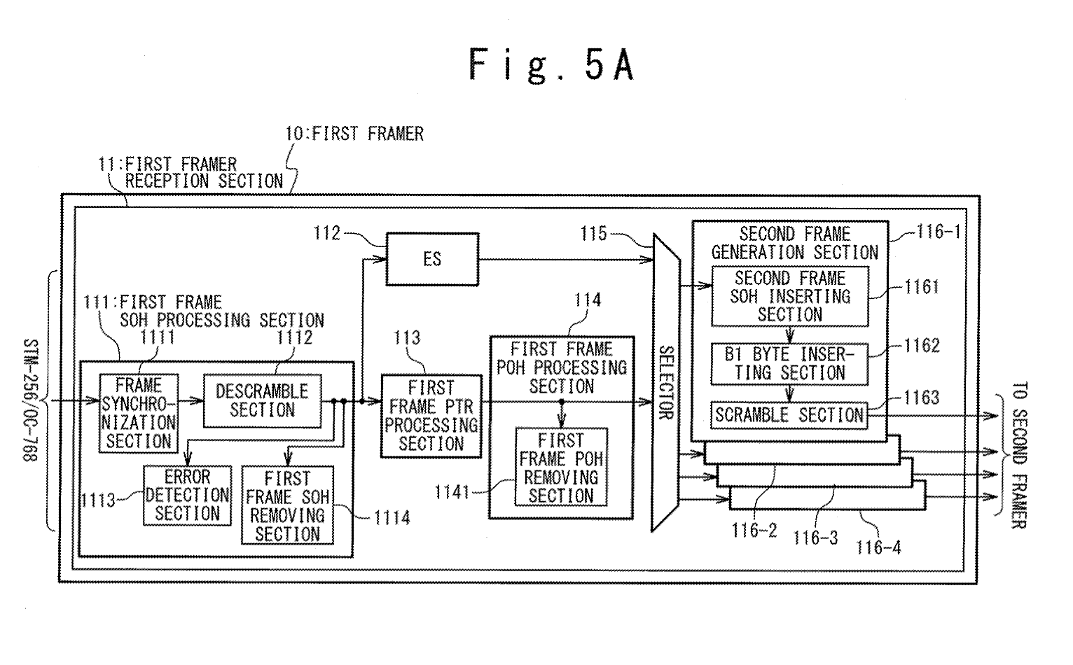

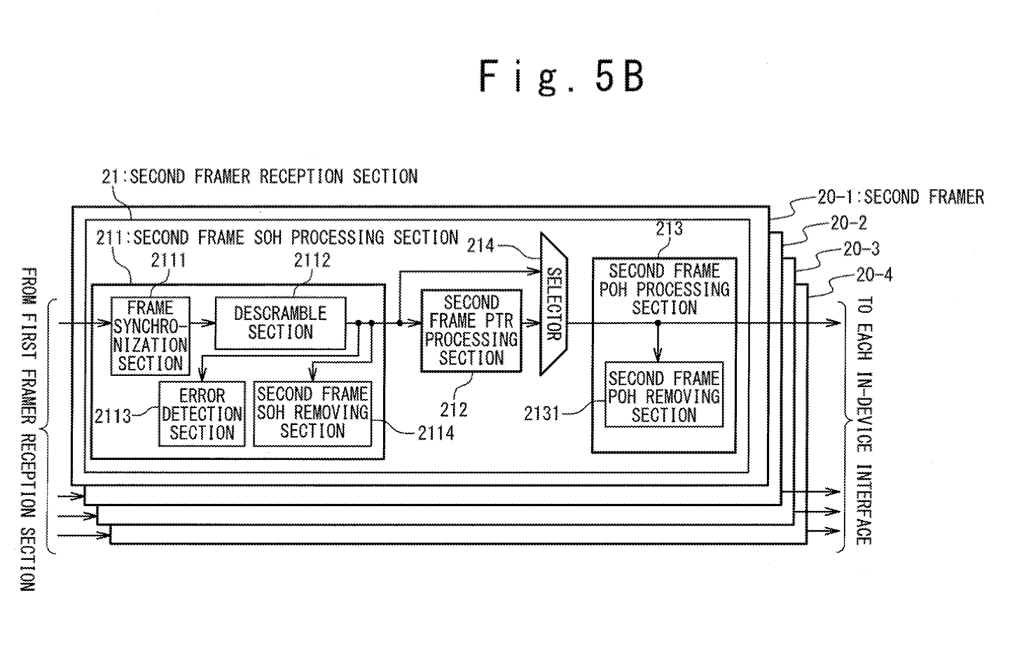

Next, referring to FIGS. 3 to 5B, the interface circuit in the present embodiment is described in more detail. FIGS. 3 to 5B are functional block diagrams illustrating the interface circuit 1 in the present embodiment in more detail. FIG. 4 is a diagram illustrating a transmission sequence of the interface circuit 1 of the present embodiment in detail. Also, FIGS. 5A and 5B are diagrams illustrating a reception sequence of the interface circuit 1 of the present embodiment in detail. FIGS. 3 to 5B are diagrams specifically illustrating FIG. 2, and therefore, for the same configurations, the same symbols are used.

First, FIGS. 3 and 4 are referred to describe the framers in the transmission sequence. The second framer transmission section 22 of the second framer 20 is first described. Referring to FIG. 3, the second framer transmission section 22 is provided with a second frame SOH inserting section 2211. As illustrated in FIG. 4, the interface circuit 1 of the present embodiment is provided with the four second framers 20-1 to 20-4. The second framer transmission section 22 of each of the second framers 20-1 to 20-4 is provided with a second frame generation section 221. Each of the second frame generation sections 221 is connected to the unillustrated in-device interface, and inserts an SOH of the second frame into the transmission data inputted from the in-device interface to generate the second frame. Each of the second frame generation sections 221 is connected to an after-mentioned second frame synchronization section 121 of the first framer transmission section 12, and outputs the generated second frame to the second frame synchronization section 121.

As illustrated in FIG. 4, each of the second frame generation sections 221 is provided with the second frame SOH inserting section 2211, a B2 byte inserting section 2212, a B1 byte inserting section 2213, and a scramble section 2214.

The second frame SOH inserting section 2211 inserts the SOH of the second frame into the transmission data inputted from the in-device interface. The B2 byte inserting section 2212 and the B1 byte inserting section 2213 respectively insert B1 byte and B2 byte into the inserted SOH. The scramble section 2214 performs scrambling for the second frame. The second frame generation section 221 transmits the second frame generated in this manner to the second frame synchronization section 121 of the first framer transmission section 12 as the STM-64/OC-192 signal. Note that such configuration and operation of the second framer transmission section 22 are the same as those of the conventional STM-64/OC-192 framer. For this reason, the second framer transmission section 22 is applicable with the conventional STM-64/OC-192 framer.

Next, the first framer transmission section 12 is described. As illustrated in FIG. 3, the first framer transmission section 12 is provided with the second frame synchronization section 121 and a first frame generation section 122. Note that the first framer transmission section 12 is provided with the second frame synchronization sections 121 by the number of the second framers 20. In the present embodiment, the first framer transmission section 12 is, as illustrated in FIG. 4, provided with four second frame synchronization sections 121-1 to 121-4. The respective second frame synchronization sections 121 are provided corresponding to the second framers 20-1 to 20-4. Each of the second frame synchronization sections 121-1 to 121-4 is connected to the second frame generation section 221 of a corresponding one of the second framers 20-1 to 20-4, and inputted with the second frame outputted from the connected second frame generation section 221. Each of the second frame synchronization sections 121-1 to 12-4 is connected to the first frame generation section 122. When the first frame generation section 122 is inputted with the second frames from the respective second frame synchronization sections 121-1 to 121-4, it multiplexes the second frames to generate the first frame. The first frame generation section 122 is connected to the unillustrated transmission path, and transmits the generated first frame to the transmission path. Note that, in the following description, the second frame synchronization sections 121-1 to 12-4 respectively have the same configurations, and are therefore described as the second frame synchronization sections 121 unless they are particularly specified.

The second frame synchronization section 121 is, as illustrated in FIG. 4, provided with a frame synchronization section 1211, a descramble section 1212, and an error detection section 1213. The frame synchronization section 1211 receives the STM-64/OC-192 signal from the corresponding second framer transmission section 22 to perform frame synchronization of the second frame. The descramble section 1212 performs descrambling for the second frame to cancel the scrambling. The error detection section 1213 obtains the B1 byte inserted into the SOH of the second frame to perform error detection and correction. Each of the second frame synchronization sections 121 outputs the second frame processed in this manner to the first frame generation section 122.

The first frame generation section 122 is, as illustrated in FIG. 4, connected to the respective second frame synchronization sections 121. The first frame generation section 122 is provided with a frame multiplexing section 1221, a first frame SOH inserting section 1222, a B2 byte inserting section 1223, a B1 byte inserting section 1224, and a scramble section 1225. The frame multiplexing section 1221 is inputted with the second frames respectively from the second frame synchronization sections 121-1 to 121-4, and performs byte multiplexing compliant with ITU-T G.707 or Telcordia GR-253-CORE to multiplex the first frame. As described, the frame multiplexing section 1221 multiplexes the STM-64/OC-192 signals inputted from the four second frame synchronization sections 121, and thereby the STM-256/OC-768 signal is generated. The first frame SOH inserting section 1222 insert an SOH of the first frame into the transmission data multiplexed by the frame multiplexing section 1221. The B2 byte inserting section 1223 and the B1 byte inserting section 1224 respectively insert the B2 byte and the B1 byte into the SOH of the first frame. The scramble section 1225 performs scrambling for the first frame. The first frame generation section 122 is connected to the transmission path, and transmits the first frame generated in this manner to the transmission path as the STM-256/OC-768 signal.

As described, the first framer transmission section 12 of the present embodiment multiplexes the second frames, which are inputted from the four second framer transmission sections 22 and compliant with STM-64/OC-192, to generate the first frame compliant with STM-256/OC-768. The second framer transmission section 22 is applicable with the conventional STM-64/OC-192 framer that generates the STM-64/OC-192 signal from the in-device interface, and the first framer transmission section 12 can specializes only in the processing of multiplexing from the second frames to the first frame.

Next, referring to FIGS. 3, 5A and 5B, the framers in the reception sequence are described. First, the first framer reception section 11 is described. Referring to FIG. 3, the first framer reception section 11 of the first framer 10 is provide with a first frame SOH processing section. 111, an ES (elastic store memory) 112, a first frame PTR processing section 113, a first frame POH processing section 114, a selector 115, and a second frame generation section 116.

The first frame SOH processing section 111 is, as illustrated in FIG. 5A, provided with a frame synchronization section 1111, a descramble section 1112, an error detection section 1113, and a first frame SOH removing section 1114. The frame synchronization section 1111 is inputted with the STM-256/OC-768 signal from the transmission path to perform frame synchronization of the first frame. The descramble section 1112 performs descrambling for the first frame to cancel the scrambling. The error detection section 1113 obtains the B1 byte and the B2 byte included in the SOH of the first frame to perform error detection and correction. The first frame SOH removing section 1114 terminates the SOH of the first frame. The first frame SOH processing section 111 outputs the first frame processed in this manner.

The first frame outputted from the first frame SOH processing section 111 is branched and inputted to the ES 112 and the first frame PTR processing section 113. In the first framer reception section of the present embodiment, processing is different between the case where the first frame stores VC4-256c in the payload and the case where the first frame stores VC4-64 or lower in the payload.

In the case where VC4-256 is stored in the payload of the first frame inputted from the first frame SOH processing section 11, the first frame PTR processing section 113 performs, on the basis of pointer information included in the SOH, pointer processing of contiguous concatenation to detect a head of the VC4-256c in the payload, and make a change from the transmission path clock to the in-device clock.

The first frame POH processing section 114 is, as illustrated in FIG. 5A, provided with a first frame POH removing section 1141. The first frame POH removing section 1141 terminates a POH of the detected VC4-256c to output it to the selector 115.

The ES 112 gives to the first frame inputted from the first frame SOH processing section 111 a delay equivalent to that in the processing performed in the first frame PTR processing section 113 and the first frame POH processing section 114, and outputs it to the selector 115.

The selector 115 is inputted with the first frames respectively from the first frame POH processing section 114 and the ES 112. The selector 115 detects, on the basis of the pointer information on the SOH of the first frame, whether the inputted signal is a signal of VC4-256c, or VC4-64c or lower. In the case where the inputted first frame stores VC4-64c or lower in the payload, the selector 115 selects the signal of the first frame inputted from the ES 112. On the other hand, in the case where the inputted first frame stores VC4-256c in the payload, the selector 115 selects the first frame signal inputted from the first frame POH processing section 114. In the present embodiment, the selector 115 performs byte separation compliant with ITU-T G.707 or Telcordia GR-253-CORE for the selected first frame signal to separate the first frame. The selector 115 outputs the first frame signal having been subjected to the byte separation to a corresponding second frame generation section 116 to be described later. Note that, in the present embodiment, the selector 115 performs the signal selection processing and signal separation processing. For example, the first framer reception section 11 may be provided with a separation section separately from the selector 115, and the respective components may be configured to separately perform these types of processing.

The first framer reception section 11 of the present embodiment is provided with the second frame generation sections 116 by the number of the second framers 20. That is, as illustrated in FIG. 5A, the first framer reception section 11 is provided with four second frame generation sections 116-1 to 116-4. Each of the second frame generation sections 116-1 to 116-4 is connected to the selector 115, and inputted with a signal separated from the first frame which is outputted from the selector 115, to generate the second frame. The respective second frame generation sections 116-1 to 116-4 are provided corresponding to the second framers 20-1 to 20-4, and connected to after-mentioned second frame SOH processing sections 211 of the second framer 20-1 to 20-4. The second frame generation section 116 outputs the generated second frame to the second frame SOH processing section 211.

The second frame generation section 116 is, as illustrated in FIG. 5A, provided with a second frame SOH inserting section 1161, a B1 byte inserting section 1162, and a scramble section 1163. The second frame SOH inserting section 1161 inserts the SOH of the second frame into the signal inputted from the selector 115. The B1 byte inserting section 1162 inserts the B1 byte for error detection into the SOH of the second frame. The scramble section 1162 performs scrambling for the second frame. The second frame generation section 116 outputs the second frame generated in this manner to the second framer reception section 21 of the second framer 20 as the STM-64/OC-192 signal.

As described, the first framer reception section 11 terminates the received first frame compliant with STM-256/OC-768; inserts the SOH of the second frame to generate the second frame compliant with STM-64/OC-192 in order to enable reception processing in the second framer reception section 21; and outputs the second frame to the second framer reception section 21. Based on this, the second framer reception section 21 can perform the same processing as that in the case of receiving the conventional second frame to process the second frame.

Next, the second framer reception section 21 is described. As described above, the interface circuit 1 of the present embodiment is provided with the four second framers 20-1 to 20-4. Each of the four second framers 20-1 to 20-4 is provided with the second frame SOH processing section 211, a second frame PTR processing section 212, a second frame POH processing section 213, and a selector 214. The second frame SOH processing section 211 of the second framer reception section 21 in each of the second framers 20-1 to 20-4 is connected to a corresponding one of the second frame generation sections 116-1 to 116-4 of the first framer reception section 11, and receives the STM-64/OC-192 signal outputted from the second frame generation section 116.

Each of the second frame SOH processing sections 211 is, as illustrated in FIG. 5B, provided with a frame synchronization section 2111, a descramble section 2112, an error detection section 2113, and a second frame SOH removing section 2114. The frame synchronization section 2111 is inputted with the STM-64/OC-192 signal outputted from the second frame generation section 116 to perform frame synchronization of the second frame. The descramble section 2112 performs descrambling for the second frame to cancel the scrambling. The error detection section 2113 obtains the B1 byte and the B2 byte from the SOH of the second frame to perform error detection and correction processing. The second frame SOH removing section 2114 terminates the SOH of the second frame. The second frame SOH processing section 211 outputs a signal of the second frame processed in this manner.

The signal of the second frame outputted from the second frame SOH processing section 211 is branched into two, which are then inputted to the selector 214 and the second frame PTR processing section 212. In the second framer reception section of the present embodiment, processing is different between the case where the second frame stores VC4-256c in the payload and the case where the second frame stores VC4-64c or lower in the payload.

In the case where the second frame stores VC4-64c or lower in the payload, the second frame PTR processing section 212 performs, on the basis of pointer information included in the SOH, pointer detection processing to detect a head of the VC4-64c or lower stored in the payload. The second framer 20 is applicable with the conventional STM-64/OC-192 framer, and the second frame PTR processing section 212 can handle various types of pointer processing for VC4-64c or lower.

The selector 214 is inputted with the signals of the second frame respectively from the second frame SOH processing section 211 and the second frame PTR processing section 212. The selector 214 detects, on the basis of the pointer information included in the SOH of the second frame, whether the payload of the second frame corresponds to VC4-256c, or VC4-64c or lower. In the case where the inputted signal corresponds to VC4-256c, the selector 214 selects the signal inputted from the second frame SOH processing section 211 to output it. On the other hand, in the case where the inputted signal corresponds to VC4-64c or lower, the selector 214 selects the signal inputted from the second frame PTR processing section 212 to output it.

The second frame POH processing section 213 is inputted with the signal of the second frame outputted from the selector. The second frame POH processing section 213 is provided with a second frame POH removing section 2131. The second frame POH removing section 2131 terminates a POH in the signal of the second frame. The second frame POH processing section 213 outputs reception data on the terminated second frame to the unillustrated in-device interface.

As described, in the case where VC4-64c or lower is stored in the payload of the second frame, the second framer reception section 21 of the present embodiment performs conventional separation processing. On the other hand, in the case where VC4-256c is stored in the payload of the second frame, the pointer processing has already been performed in the first framer reception section 11, and therefore POH termination processing is performed through the selector 214 without performing the pointer processing.

Note that, a function of bypassing the payload processing in the case where the payload stores VC4-256c in the second framer as described is loaded in a typical STM-64/OC-0192 (second frame) framer as an interface for APS (Automatic Protection Switching), and can be applied.

The above describes the interface circuit in the present embodiment. As described, in the interface circuit of the present embodiment, the first framer transmission section 12 selectively performs only the processing of generating the first frame compliant with STM-256/OC-768 from the second frames compliant with STM-64/OC192. Also, the first framer reception section 11 makes the second framer 20 process STM-64/OC-192 or lower. The first framer 10 makes the interface common with the second framer 20 to enable transmission/reception of the second frame. For this reason, the second framer 20 is only required to perform the conventional processing that targets STM-64/OC-192 or lower, and therefore applicable with the conventional STM-64/OC-192 framer. Further, regarding the pointer processing, the first framer 10 performs the contiguous concatenation processing of VC4-256c, and the second framer 20 performs only the processing of VC4-64c or lower to bypass the payload of VC4-256c, whereby all types of pointer processing for VC4-256c or lower can be handled.

Note that the second framer 20 is not limited to the STM-64/OC-192 framer. For example, the second framer 20 may be an STM-16/OC-48 framer. In such a case, the interface circuit 1 is provided with sixteen second framers so as to correspond to STM-256/OC-768 serving as the first framer. Also, the first framer is provided with the second frame synchronization sections 121 and the second frame generation sections 116 correspondingly to the number of the second framers.

Based on such a configuration, only by adding the first framer, which corresponds to the transmission/reception interface with the second framer, to the conventional second framer 20, the interface circuit corresponding to the STM-256/OC-768 can be realized. For this reason, a newly designed circuit can be prevented from increasing in size, and an interface circuit can be realized through simple design.

The embodiments of the present invention described above can be combined as necessary within a range that has no contradiction.

What is claimed is:

1. An interface circuit comprising:
a first framer configured to input or output a first standard frame compliant with a first standard to or from a transmission path; and
a second framer connected to said first framer and configured to input or output a second standard frame compliant with a second standard from or to an in-device interface,
wherein said second framer comprises:
a second framer transmission section configured to input a transmission data from said in-device interface and generate a second standard frame with said transmission data in a payload,
wherein said first framer comprises:
a first framer transmission section connected to said second framer transmission section and configured to input said generated second standard frame from said second framer transmission section, generate a first standard frame with said generated second standard frame and output said generated first standard frame to said transmission path; and
a first framer reception section configured to input a first standard frame from said transmission path, terminate said inputted first standard frame and generate a second standard frame with a reception data stored in a payload of said inputted first standard frame,
wherein said second framer further comprises:
a second framer reception section connected to said first framer reception section and configured to input said generated second standard frame from said first framer reception section, terminate said inputted second standard frame and output said reception data stored in said inputted second standard frame to said in-device interface.

2. The interface circuit according to claim 1 further comprising:
a plurality of said second framers;
a plurality of said second framer transmission sections; and
a plurality of said second framer reception sections,
wherein each of said plurality of second framers comprises each of said plurality of second framer transmission sections and each of said plurality of second framer reception sections,
wherein said each second transmission section is configured to input a transmission data from said in-device interface and generate a second standard frame with said transmission data in a payload,
wherein said first transmission section is connected to said each second transmission section and configured to input said generated second standard frame from said each second framer transmission section, multiplex a group of said second standard frames inputted from said each second framer transmission section, generate a first standard frame with said multiplexed group of second standard frames and output said generated first standard frame to said transmission path,
wherein said first framer reception section is configured to input a first standard frame from said transmission path, terminate said inputted first standard frame and generate a plurality of second standard frames each of which stores reception data in a payload of said inputted first standard frame, and
wherein said each second framer reception section is connected to said first standard framer reception section and configured to respectively input each of said plurality of generated second standard frames from said first framer reception section, terminate said each inputted second standard frame and output said reception data stored in said each inputted second standard frame to said in-device interface.

3. The interface circuit according to claim 2 wherein:
said first framer reception section comprises:
a first frame SOH (Section OverHead) processing section configured to terminate an SOH of said first standard frame;
a first frame PTR (PoinTeR) processing section configured to detect a head of a data compliant to said first standard based on a pointer information in said SOH in a case in which said data compliant to said first standard is stored in a payload of said first standard frame;
a first frame POH (Path OverHead) processing section configured to terminate a POH of said data compliant to said first standard;
a selector configured to separate said first standard frame; and
a second frame generation section configured to generate a second standard frame which stores a payload of said separated first standard frame.

4. The interface circuit according to claim 3 wherein:
said first framer reception section further comprises an ES (Elastic Store memory) configured to input a payload data of said first standard frame from said first frame SOH processing section and give a delay equivalent to that in the processing performed in said first frame PTR processing section and said first frame POH processing section to said payload data of said first standard frame; and
said selector is configured to input a payload data of said first standard frame from each of said ES and said first frame POH processing section, select based on a pointer information in SOH of said first framer and separate a payload data inputted from said first frame POH processing section in a case in which data compliant with said first standard is stored in a payload of said first standard frame, and select and separate a payload data inputted from said ES in a case in which a data compliant with said second standard is stored in a payload of said first standard frame.

5. The interface circuit according to claim 4 wherein said second framer reception section comprises:
a second frame SOH processing section configured to terminate a SOH of said second standard frame;
a second frame PTR processing section configured to detect a head of said data compliant with said second standard based on a pointer information in said SOH in a case in which said data compliant with said second standard is stored in a payload of said second standard frame;
a selector configured to input a payload data of a second standard frame from said second frame SOH processing section and said second frame PTR processing section, output a payload data of said second standard frame inputted from said second frame SOH processing section in a case in which a data compliant with said first standard is stored in a payload of said second standard frame based on a pointer information in said SOH of said second standard frame, and output a payload data of said second standard frame inputted from said second frame PTR processing section in a case in which a data compliant with said second standard is stored in a payload of said second standard frame; and
a second frame POH processing section configured to terminate a payload data of said second standard frame.

6. The interface circuit according to claim 5 wherein:
said first standard is STM-256 provided in ITU-T (International Telecommunication Union Telecommunication Standardization Sector) G.707, or OC-768 provided in Telcordia GR253; and
said second standard is STM-64 provided in ITU-T G.707, or OC-192 provided in Telcordia GR-253-CORE.

7. A method of transmitting and receiving data comprising:
inputting a transmission data from an in-device interface;
generating a second standard frame with said transmission data in a payload;
generating a first standard frame with said generated second standard frame;
outputting said generated first standard frame to a transmission path;
inputting a first standard frame from said transmission path;
terminating said inputted first standard frame;
generating a second standard frame with a reception data stored in a payload of said inputted first standard frame;
terminating said generated second standard frame; and
outputting said reception data stored in said inputted second standard frame to said in-device interface.
